(19) United States
(12) Patent Application Publication
(10) Pub. No.: US 2008/0253233 A1
(43) Pub. Date: Oct. 16, 2008

(54) Orgasm clock

(76) Inventor: Patrick Michael Dinkfeld, Santa Monica, CA (US)

Correspondence Address: PATRICK MICHAEL DINKFELD, #14, 1145 YALE ST., SANTA MONICA, CA, 90403, US

(21) Appl. No.: 11/825,612

(22) Filed: Jul. 9, 2007

Related U.S. Application Data
(60) Provisional application No. 60/922,915, filed on Apr. 12, 2007.

(51) Int. Cl. G04C 23/00

(52) U.S. Cl. 368/75

(57) ABSTRACT

The Orgasm Clock is a clock that chimes every hour with a different female orgasm sound each hour and is intended for entertainment. The Orgasm Clock has a clock face with female figures on every hour in the place of numbers.

### CROSS REFERENCE

Provisional Patent Appl. No. 60/922/915—Dated Apr. 12, 2007

### FEDERALLY SPONSORED RESEARCH OR DEVELOPMENT

N/A

### SEQUENCE LISTING

N/A

### BACKGROUND OF INVENTION

The Orgasm Clock is intended for entertainment.

### BRIEF SUMMARY OF THE INVENTION

The Orgasm Clock is a clock that chimes every hour with a different female orgasm sound each hour. The Orgasm clock is intended for entertainment.

### BRIEF DESCRIPTION OF THE SEVERAL VIEWS OF THE DRAWING

N/A

### DETAILED DESCRIPTION OF THE INVENTION

The Orgasm Clock has a clock face with female figures on every hour in the place of numbers. The Orgasm Clock chimes every hour with a different female orgasm sound each hour.

1. The Orgasm Clock is intended for entertainment. Every hour on the hour the clock will chime with a different female orgasm sound.
